(19) United States
(12) Patent Application Publication
(10) Pub. No.: US 2025/0162810 A1
(43) Pub. Date: May 22, 2025

(54) Method and Means for Monitoring a Conveying Device

(71) Applicant: Deutsche Post AG, Bonn (DE)

(72) Inventor: Stefan BREIDUNG, Leipzig (DE)

(21) Appl. No.: 18/913,167

(22) Filed: Oct. 11, 2024

(30) Foreign Application Priority Data
Nov. 16, 2023 (DE) 10 2023 132 004.1

(51) Int. Cl. B65G 43/02; G01V 8/14

(52) U.S. Cl. CPC B65G 43/02; G01V 8/14; B65G 2203/044

(57) ABSTRACT

A computer-implemented method for monitoring a conveying device, wherein the conveying device comprises a plurality of elements and is designed such that the plurality of elements are movable along a conveying direction of the conveying device, includes the steps of: receiving a first signal, wherein the first signal represents sound generated during the operation of the conveying device; receiving a second signal, wherein the second signal represents a time when an element of the conveying device passes through a light barrier; assigning the received first signal to elements of the conveying device, taking into account the received second signal; and monitoring the conveying device by analyzing the assigned first signal.

### CROSS-REFERENCE TO RELATED APPLICATIONS

The present application is based upon and claims the right of priority to DE Patent Application No. 10 2023 132 004.1, filed Nov. 16, 2023, the disclosure of which is hereby incorporated by reference herein in its entirety for all purposes.

### TECHNICAL FIELD

The invention relates to a computer-implemented method for monitoring a conveying device.

The invention further relates to a data processing device comprising means to carry out the above method, a computer program product comprising commands which, when the program is executed by a computer, prompt said computer to carry out the above method, and a computer-readable data medium on which the above computer program product is stored.

The invention further relates to a system comprising a conveying device and the above data processing device.

### BACKGROUND TO THE INVENTION

Conveying devices and, in particular, sorters as logistical sorting and distribution systems for transporting and/or sorting objects, in particular unit goods, are known in the prior art. As a result of e-commerce and online mail-order offerings, the number of unit goods to be transported and/or sorted has increased significantly. The reliability of the conveying devices is correspondingly important, since technical problems in each case run the risk of unplanned downtime of the conveying device. This is associated with substantial delays, capacity restrictions and costs.

A need therefore exists for means to monitor the conveying device in order to draw attention to potential problems at an early stage. There is a particular need for such monitoring means which identify future and possibly worsening faults at a very early stage so that countermeasures can be instigated to avoid any downtime of the conveying device. Moreover, the disadvantage of known monitoring systems is, inter alia, that they are only capable of establishing the existence of a possible malfunction, but do not enable any assignment of the fault to individual components of the conveying devices. The subsequent fault investigation is correspondingly time-consuming.

### DESCRIPTION OF THE INVENTION

Against this background, one object of the present invention is to improve the monitoring of conveying devices and, in particular, to enable the assignment of a fault potentially occurring in future to a specific component of the conveying device.

The object of the invention is achieved by the features of the independent claims. Advantageous embodiments are indicated in the dependent claims.

The object is achieved accordingly by a computer-implemented method for monitoring a conveying device, wherein the conveying device comprises a plurality of elements and is designed such that the plurality of elements are movable along a conveying direction of the conveying device, comprising the steps of:
receiving a first signal, wherein the first signal represents sound generated during the operation, and in particular the normal operation, of the conveying device,
receiving a second signal, wherein the second signal represents a time when an element of the conveying device passes through a light barrier,
assigning the received first signal to elements of the conveying device, taking into account the received second signal, and
monitoring the conveying device by analyzing the assigned first signal.

The object is further achieved by a data processing device comprising means to carry out the above method.

The object is further achieved by a computer program product comprising commands which, when the program is executed by a computer, prompt said computer to carry out the above method.

The object is further achieved by a computer-readable data medium on which the above computer program product is stored.

The object is further achieved by a system comprising a conveying device, the above data processing device, at least one microphone and at least one light barrier, wherein the conveying device comprises a plurality of elements and is designed such that the plurality of elements are movable along a conveying direction of the conveying device, wherein the microphone is designed to generate a first signal on the basis of sound, wherein the light barrier comprises a light source and a light sensor and is designed to generate a second signal on the basis of optical signals, and wherein the microphone and the light barrier have a communication connection to the data processing device such that the first and second signal are receivable by the data processing device.

According to one aspect of the invention, the first signal representing the sound is assigned to individual elements of the conveying device through the reception of the second signal representing the passage of an element of the conveying device through the light barrier. In other words, the second signal performs the function of a timestamp for the passage of an element through the light barrier. Formulated again in other words, a temporal assignment is preferably performed between the second and the first signal. In the subsequent analysis of the first signal, this enables not only the identification of the existence of a fault or future potential fault, but also the assignment of this fault to a specific element of the conveying device as the source of the fault. Targeted maintenance of the conveying device and, in particular, timely maintenance of the element of the conveying device identified as the fault source can be carried out accordingly.

The first signal is therefore received in the first step of the computer-implemented method. The first signal preferably represents a sound generated during the operation and, in particular, the normal operation of the conveying device. In other words, a time-continuous physical parameter, in particular the sound pressure, generated by the operation of the conveying device is preferably represented by the first signal. The first signal is preferably a digital signal and further preferably a time-discrete digital signal which is received by the data processing device for further evaluation in the first step. The digital signal can be derived from an analog audio signal through conversion.

The second signal is received in the second step of the method. The second signal preferably represents a time when an element of the conveying device passes through the light barrier. The second signal is preferably a time-discrete signal and, in particular, a digital signal. In other words, an optical signal generated at the light barrier by the movement of the elements along the conveying direction is therefore preferably converted into a digital signal which is then received by the data processing device in the second step for further evaluation.

After the first signal has been assigned to elements of the conveying device by taking account of the second signal, the monitoring of the conveying device then takes place through analysis of the assigned first signal. Taking account of the second signal particularly preferably comprises assigning the first and second signal to one another on the basis of the time of the two signals.

According to one preferred development of the invention, it is provided that the monitoring of the conveying device comprises identifying an irregular element of the conveying device. An irregular element is preferably understood to mean an element which deviates in its function from the norm. An irregular element does not yet necessarily have to result in a malfunction of the conveying device. However, the presence of an irregular element normally increases the probability that such a malfunction of the conveying device will take place in future. The identification of irregular elements therefore enables pre-emptive maintenance of the conveying device in which the conveying device can be predictively maintained. This enables cost savings compared with routine or time-based preventive maintenance strategies, since maintenance then has to be carried out only if it is also justified by the existence of an irregular element.

According to a further development of the invention, it is particularly preferably provided that the monitoring of the conveying device is performed by means of machine learning and/or statistical methods. This enables reliable identification of the irregular elements, specifically geared toward the conveying device and its environment. The statistical methods preferably use dynamic and/or rolling statistical surveys for the monitoring.

According to one preferred further development of the invention, it is provided that the first received signal comprises amplitude values for consecutive times. It is further preferably provided that the method comprises the step of determining frequencies contained in the first signal. In other words, the spectrum of the first signal is preferably determined, and the spectrum is particularly preferably determined in temporally consecutive signal segments of the first signal. The proportion of frequencies contained in the time characteristic in the first signal can be determined in this way. This enables the identification of irregular elements of the conveying device through analysis of the amplitude values at the respective frequencies and/or in predefined frequency ranges. In particular, it has been established that irregular elements of the conveying device have higher amplitude values in specific frequency ranges.

According to one preferred further development of the invention it is provided that amplitude values are obtained for each element of the conveying device at a plurality of frequencies and at a plurality of times through the step of assigning the received first signal to elements of the conveying device, taking account of the received second signal. An element-related analysis of the first signal therefore preferably takes place.

According to a further preferred development of the invention, it is provided that the step of assigning the received first signal to elements of the conveying device, taking account of the received second signal, comprises taking account of the conveying speed of the conveying device, the length of the conveying device along the conveying direction and/or the number of elements of the conveying device. In particular, the first signal can be assigned precisely to the respective elements of the conveying device by means of the conveying speed, by means of the length of a conveying device preferably designed as a circuit and/or by means of the number of elements.

According to a further preferred development of the invention, it is provided that the method comprises the step of checking the received first signal, taking account of the received second signal, and rejecting the received first signal if the received first signal is not regular in the time axis. In order to exclude the possibility of poor quality of the first signal resulting in a false conclusion regarding the identification of irregular elements, it is, in other words, preferably provided that the first signal is checked in terms of its regularity in the time axis. This check is particularly preferably carried out, taking account of comparative data, by means of machine learning and/or statistical methods. In relation to machine learning, it is particularly preferably provided that an algorithm generates a model on the basis of the comparative data in order to distinguish between regular and irregular first signals. On the basis of the already detected and then known faults, it is therefore also possible for the algorithm to identify fault types and perform an automated fault classification.

In relation to the monitoring, it is provided according to a further preferred development of the invention that the monitoring of the conveying device comprises comparing an amplitude value in one frequency band with a limit value. The limit value is preferably a frequency-band-dependent limit value. It is further preferably provided that the monitoring of the conveying device comprises comparing the amplitude values in all frequency bands with the frequency-band-dependent limit values. The limit value and/or the frequency-band-dependent limit values are particularly preferably determined taking account of the comparative data using dynamic and/or rolling statistical surveys. Alternatively or additionally, it can be provided to determine the limit value and/or the frequency-dependent limit values by means of machine learning.

According to a further preferred development, it is preferably provided in this connection that the limit value is an element-dependent limit value. Particularly if the conveying device has elements that are designed differently from one another, for example elements with their own drive and/or elements with brushes, some of the elements will be louder than other elements due to the configuration of the individual elements. It is accordingly advantageous that the limit value is an element-dependent limit value, since different elements can thus be considered differently in the evaluation and, for example, generally louder elements can be evaluated separately.

According to one preferred development of the invention, it is further provided that the method comprises the step of generating a warning and/or an alarm if the limit value is exceeded in one specific frequency band and/or if the limit value is exceeded in a plurality of frequency bands. This enables efficient maintenance of the conveying device. Warnings are preferably generated for elements which have higher amplitude values than the limit value, while alarms are triggered for elements of which the amplitude values come close to the limit value for the frequency range multiple times within a predefined time period.

According to a further preferred development of the invention, it is provided in this connection that the monitoring of the conveying device comprises comparing an amplitude value with a limit value over a plurality of cycles of the conveying device. This offers the advantage that one-off effects, such as, for example, a background noise having a high amplitude and/or interfering noises due to inadequately packed unit goods, do not directly result in the generation of a warning and/or an alarm, since these effects do not persist over a plurality of cycles of the conveying device. A warning and/or an alarm is/are therefore preferably generated only if the limit value is exceeded in a predefined number of cycles out of a plurality of cycles. In other words, a warning and/or an alarm can therefore be generated only if an increased amplitude persists over a plurality of cycles of the conveying device. Alternatively, it can also be provided that the monitoring of the conveying device comprises forming a mean amplitude value over a plurality of amplitude values and the mean amplitude value is compared with the limit value. The method is therefore particularly suitable for enabling monitoring during the normal operation of the conveying device, since it is capable of distinguishing first signals representing the sound of defective elements from first signals representing the sound of one-off effects, such as, for example, the transport of particularly heavy unit goods on the conveying device. In other words, the monitoring of the conveying device is preferably performed such that assigned first signals which are attributable to irregular elements of the conveying device are distinguishable from assigned first signals which are attributable to unit goods arranged irregularly on the conveying device and/or which are attributable to unit goods deviating from the norm.

Further technical features and advantages of the method for monitoring the conveying device will be evident to a person skilled in the art from the following description of the data processing device, the computer program product, the computer-readable data medium and the system.

As already mentioned, the invention also relates to a data processing device comprising means to carry out the method described above. The data processing device is particularly preferably server-based. The data processing device preferably comprises means for receiving the first and/or second signal. The data processing device further preferably comprises at least one memory for storing the first signal and/or the second signal, and/or a programmable computing unit.

The invention further relates to the computer program product comprising commands which, when the program is executed by a computer, prompt said computer to carry out the above method. The invention further relates to the computer-readable data medium on which the computer program product described above is stored.

The technical effects and advantages of the data processing device, the computer program product and/or the computer-readable data medium will become clear to a person skilled in the art from the above description of the computer-implemented method for monitoring the conveying device, and from the following description of the system comprising the conveying device and the data processing device.

As already explained, the object of the invention is also achieved by the system comprising the conveying device, the data processing device described above, at least one microphone and at least one light barrier, wherein the conveying device comprises a plurality of elements and is designed such that the plurality of elements are movable along a conveying direction of the conveying device, wherein the microphone is designed to generate a first signal on the basis of sound, wherein the light barrier comprises a light source and a light sensor and is designed to generate a second signal on the basis of optical signals, and wherein the microphone and the light barrier have a communication connection to the data processing device such that the first and second signal are receivable by the data processing device.

It is preferably provided that the microphone is designed to represent the sound pressure generated during the operation of the conveying device in the form of the first preferred signal, i.e. preferably in the form of a digital signal, and to forward it to the data processing device via a communication connection. It is further preferably provided that the light barrier is designed to represent the optical signal by means of the preferably digital second signal and to forward it to the data processing device via a communication connection. The first and/or second signal can be forwarded by wireless or wired means.

The conveying device is preferably designed for transporting and/or sorting objects, in particular unit goods. In this connection, it is provided according to one preferred development of the invention that the conveying device is designed as a circuit and/or that the plurality of elements are movable synchronously along the conveying direction and/or that the elements are designed to move objects arranged on the elements perpendicularly to the conveying direction.

The elements of the conveying device can all be designed as of the same type. Alternatively, it is possible for the elements of the conveying device to be designed differently from one another. In other words, it can be provided that the conveying device comprises differently designed elements-for example elements having their own drive and/or elements with brushes. At least some elements of the conveying device particularly preferably comprise a conveyor belt and are designed to move objects arranged on the element perpendicularly to the direction of the circuit.

According to a further preferred development of the invention, it is provided in this connection that the conveying device is designed as a crossbelt sorter and/or that the element comprises a belt conveyor and/or band conveyor. The object can accordingly be moved in a very simple manner perpendicularly to the conveying direction of the conveying device.

The microphone can essentially be fitted at different locations on the conveying device, for example on a straight section of the conveying device. With regard to the arrangement of the microphone, it is provided according to a further preferred development of the invention that the microphone is arranged in relation to the conveying device such that sound generated in a curve of the conveying device is within the receive range of the microphone and/or that the microphone is at a distance of no more than 1 m from a curve of the conveying device and is particularly preferably arranged in the curve radius of the conveying device. Since the elements of the conveying device normally have main rollers and side rollers and the side rollers are in contact, particularly in curves, with further parts of the conveying device, the arrangement of the microphone close to the curve also enables the reception of sound generated by the running of the side rollers. The reliability of the method for monitoring the conveying device is increased accordingly by this arrangement.

In connection with the arrangement of the microphone, it is provided according to a further preferred development of the invention that the microphone is arranged on a static component of the conveying device and/or below an underside of the elements of the conveying device. This enables particularly good reception of sound from the conveying device and, in particular, sound generated by the running of the main rollers and/or side rollers.

With regard to the light barrier, it is preferably provided that the light sensor of the light barrier generates the second signal on the basis of an optical signal from the light source reflected on the elements of the conveying device. The time when an element of the conveying device passes through the light barrier can thus be determined in a precise manner. A sensitivity threshold of the light sensor is particularly preferably exceeded through reflection, resulting in the generation of the second signal.

In this connection, it is provided according to a further preferred development of the invention that at least one element of the conveying device is equipped with a reflector, and that the light source of the light barrier is preferably arranged in relation to the conveying device such that a light beam from the light source strikes the reflector perpendicularly when the element passes through. The system is preferably designed such that only one element out of the plurality of elements of the conveying device is equipped with a reflector. Accordingly, the time when this one element passes through is preferably used by the method to assign the first signal to the elements of the conveying device on the basis of the conveying speed, the length of the conveying device and/or the number of elements. Alternatively, however, a plurality of elements of the conveying device can also be equipped with a reflector.

### BRIEF DESCRIPTION OF THE DRAWINGS

The invention is explained in detail below on the basis of a preferred exemplary embodiment with reference to the attached drawings.

In the drawings:

FIG. 1 shows a schematic view of a system, according to one preferred exemplary embodiment of the invention, and

FIG. 2 shows a schematic view of a section of the system shown in FIG. 1.

### DETAILED DESCRIPTION OF THE EXEMPLARY EMBODIMENT

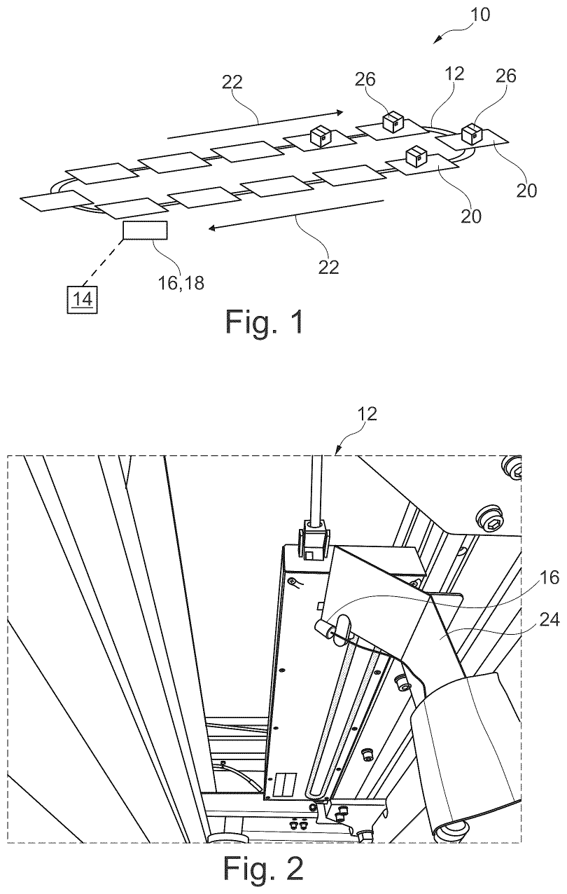

FIG. 1 shows a schematic view of a system 10 comprising a conveying device 12, a data processing device 14, a microphone 16 and a light barrier 18, according to one preferred exemplary embodiment of the invention.

The conveying device 12 is designed here as a crossbelt sorter 12 and comprises a plurality of elements 20 that are movable in a circuit along a conveying direction 22. The microphone 16 is designed to generate a first signal on the basis of sound. The first signal is a digital signal here. The light barrier 18, which comprises a light source and a light sensor, is designed to generate a second signal on the basis of optical signals. The second signal is also a digital signal here. The microphone 16 and the light barrier 18 are arranged here directly in front of a curve of the circuit of the conveying device 12.

The microphone 16 and the light barrier 18, which are both shown only schematically in FIG. 1, have a communication connection to the data processing device 14 such that the first and second signal are receivable by the data processing device 14.

FIG. 2 shows a schematic view of a section of the system 10 shown in FIG. 1. FIG. 2 shows, in particular, that the microphone 16 is arranged on a static component 24 of the conveying device 12. The microphone 16 is arranged here below an underside of the elements 20 of the conveying device 12 at a distance of around 50 cm from the elements 20.

The data processing device 14 is configured to carry out the computer-implemented method described below for monitoring the conveying device 12.

The first signal is received in one step of the method, wherein the first signal represents sound generated during the normal operation of the conveying device 12. The arrangement of unit goods 26 on some of the elements 20 in FIG. 1 indicates that the conveying device 12 is operating normally in the present case.

The second signal is received in a further step of the method, wherein the second signal represents a time when an element 20 of the conveying device 12 passes through the light barrier 18.

In a step following the preceding steps, the received first signal is assigned to the elements 20 of the conveying device 12, taking account of the received second signal.

The conveying device 12 is subsequently monitored in a further step by analyzing the assigned first signal.

In the present exemplary embodiment, precisely one element 20 of the conveying device 12 has a reflector so that the light barrier 18 detects the time when this one element 20 passes through the light barrier 18. The received first signal can be assigned to the corresponding elements 20 of the conveying device 12 by means of this time which acts as a timestamp.

A sequence of amplitude values for each element 20 is obtained accordingly for each cycle of the conveying device 12. In the present exemplary embodiment, a configurable number of historical comparative data are taken into account for monitoring the conveying device 12. The default value for the number of days of historical comparative data that are taken into account is 15 days, but 7 days have proven to be sufficient. In the present exemplary embodiment, the data from the last 15 days are taken into account as historical comparative data. Since the received first signal is checked here for its regularity in its time axis, taking into account the received second signal, and irregular signals are rejected, this typically results in around 100,800 data sequences with amplitude values for a conveying device 12 comprising 1400 elements, with around 60 evaluable cycles of the conveying device per working day. Each data sequence with amplitude values contains approximately 43 individual amplitude values.

Irregular elements 20 of the conveying device 12 are identified in the present exemplary embodiment during the monitoring of the conveying device 12. This is made possible since it has been established that irregular elements 20 generate higher amplitudes than non-irregular elements 20 in some frequency ranges. If one element 20 therefore has higher amplitudes than other elements 20 of the conveying device 12 for one specific frequency range, the probability that the element 20 is defective is high.

In this preferred exemplary embodiment, frequency-band-dependent limit values are determined by means of statistical methods, taking account of the historical comparative data. Each frequency range is then checked for each element 20 during the monitoring of the conveying device 12. Warnings are generated for elements 20 which have significantly increased amplitude values, while alarms are triggered for elements 20 having amplitude values which regularly come close to the limit value for one specific frequency range. The elements 20 identified as irregular can be maintained accordingly in a targeted manner.

The exemplary embodiment described is merely an example which can be modified and/or supplemented in various ways within the scope of the claims.

### REFERENCE SIGN LIST

System 10
Conveying device 12
Data processing device 14
Microphone 16
Light barrier 18
Element 20
Conveying direction 22
Static component 24
Unit goods 26

1. A computer-implemented method for monitoring a conveying device, wherein the conveying device comprises a plurality of elements and is designed such that the plurality of elements is movable along a conveying direction of the conveying device, comprising the steps of:
receiving a first signal, wherein the first signal represents sound generated during the operation of the conveying device,
receiving a second signal, wherein the second signal represents a time when an element of the conveying device passes through a light barrier,
assigning the received first signal to elements of the conveying device, taking into account the received second signal, and
monitoring the conveying device by analyzing the assigned first signal.

2. The method according to claim 1, wherein the monitoring of the conveying device comprises identifying an irregular element of the conveying device, and/or wherein the monitoring of the conveying device is performed by means of machine learning and/or statistical methods.

3. The method according to claim 1, wherein the first received signal comprises amplitude values for consecutive times and/or wherein the method comprises the step of determining frequencies contained in the first signal.

4. The method according to claim 1, wherein the step of assigning the received first signal to elements of the conveying device, taking account of the received second signal, comprises taking account of the conveying speed of the conveying device, the length of the conveying device along the conveying direction and/or the number of elements of the conveying device.

5. The method according to claim 1, wherein the method comprises the step of checking the received first signal, taking account of the received second signal, and rejecting the received first signal if the received first signal is not regular in the time axis.

6. The method according to claim 1, wherein the monitoring of the conveying device comprises comparing an amplitude value in one frequency band with a limit value and/or wherein the method comprises the step of generating a warning and/or an alarm if the limit value is exceeded in one specific frequency band and/or if the limit value is exceeded in a plurality of frequency bands.

7. The method according to claim 1, wherein the monitoring of the conveying device comprises comparing an amplitude value with a limit value over a plurality of cycles of the conveying device; and/or
wherein the monitoring of the conveying device is performed such that assigned first signals which are attributable to irregular elements of the conveying device are distinguishable from assigned first signals which are attributable to unit goods arranged irregularly on the conveying device and/or which are attributable to unit goods deviating from the norm.

8. A data processing device comprising means to carry out the method according to claim 1.

9. A non-transitory computer-readable data medium, on which the computer program product according to claim 1.

10. A system comprising a conveying device, a data processing device designed according to claim 8, at least one microphone and at least one light barrier,
wherein the conveying device comprises a plurality of elements and is designed such that the plurality of elements is movable along a conveying direction of the conveying device,
wherein the microphone is designed to generate a first signal on the basis of sound,
wherein the light barrier comprises a light source and a light sensor and is designed to generate a second signal on the basis of optical signals, and
wherein the microphone and the light barrier have a communication connection to the data processing device such that the first and second signal are receivable by the data processing device.

11. The system according to claim 10, wherein the conveying device is designed as a circuit and/or wherein the plurality of elements is movable synchronously along the conveying direction and/or wherein the elements are designed to move objects arranged on the elements perpendicularly to the conveying direction.

12. The system according to claim 10, wherein the microphone is arranged in relation to the conveying device such that sound generated in a curve of the conveying device is within the receive range of the microphone and/or wherein the microphone is arranged at a distance of no more than 1 m from a curve of the conveying device.

13. The system according to claim 10, wherein the microphone is arranged on a static component of the conveying device and/or below an underside of the elements of the conveying device.

14. The system according to claim 10, wherein at least one element of the conveying device is equipped with a reflector, and wherein the light source of the light barrier is arranged in relation to the conveying device such that a light beam from the light source strikes the reflector perpendicularly when the element passes through.
